(19) United States
(12) Patent Application Publication
(10) Pub. No.: US 2004/0222285 A1
(43) Pub. Date: Nov. 11, 2004

(54) Computer automated electronic small change harvesting method

(76) Inventor: Bernhardt Pohl, Pretoria (ZA)

Correspondence Address: CHARMASSON & BUCHACA & LEACH LLP, 1545 HOTEL CIRCLE SOUTH, SUITE 150, SAN DIEGO, CA, 92108-3412, US

(21) Appl. No.: 10/867,186

(22) Filed: Jun. 14, 2004

Related U.S. Application Data
(63) Continuation-in-part of application No. PCT/ZA01/00203, filed on Dec. 14, 2001.

(51) Int. Cl. G06F 17/60

(52) U.S. Cl. 235/379

(57) ABSTRACT

This invention provides for method 10 of automatically harvesting a monetary donation during a financial transaction. The method 10 includes the steps of electronically registering 12 tender received from a transacting party which tender is offered as payment for goods and/or services; automatically and electronically determining 14 whether or not the tendered amount exceeds the total amount 16 required for the purchase of the goods and/or services; automatically and without approval from the transacting party increasing 20 the total amount of the transaction with a predetermined amount if the tendered amount exceeds the total amount 16 required so that the predetermined amount is equal or less than the difference between the total amount and the tendered amount; and automatically and electronically allocating 22 the predetermined amount to a collecting party 24 if the transacting party does not disagree to the automatic increase of the total amount with the predetermined amount. The invention further provides for an accompanying system.

### PRIOR APPLICATION

This is a Continuation-in-Part of co-pending International Application No. PCT/ZA01/00203, with an international filing date of Dec. 14, 2001.

### FIELD OF THE INVENTION

This invention relates to a method and system for automatically harvesting a monetary donation during a financial transaction, and a method and system for automatically harvesting a monetary donation after the conclusion of an electronic transaction.

### BACKGROUND TO THE INVENTION

Due to the large number of financial transactions occurring daily, small change is frequently generated. This generated small change is generally not productively applied due to its fragmented state and therefore perceived redundancy. The current invention seeks to automatically harvest this generated change through exploiting this perceived redundancy.

The Inventor is aware of existing systems for gathering donations at cash registers. For example, in WO 0021009, a “ . . . donation collection and processing system” is disclosed which uses a separate “ . . . fundraising device electronically linked to and in proximity with an electronic cash register.” The system disclosed in WO 0021009 further requires a customer to choose from a list of charities after a purchase and accordingly make a donation to the selected charity. Similarly, in U.S. Pat. No. 6,112,191, a subscriber is able to accumulate credits in a separate surplus account from where the credits are apportioned to charities nominated by the subscriber. These surplus accounts are typically identified by means of a card having an electromagnetic strip thereon. Also, in U.S. Pat. No. 5,466,919, a system is disclosed which enables a customer to donate money to a charity when making purchases with a credit card which is associated with a specific charity.

The Inventor has identified several shortcomings in the known systems. A major problem of these systems is that their operation requires a customer to perform a conscious decision to make a donation following a transaction which results in less efficient donation harvesting than the system proposed under this invention. Furthermore, several of the known systems are dependant on additional hardware which adds to complexity and operation costs. The proposed invention seeks to improve upon the above inventions.

### SUMMARY OF THE INVENTION

According to a first aspect of the invention there is provided a method of automatically harvesting a monetary donation during a financial transaction which method includes the following steps, in any order

electronically registering tender received from a transacting party which tender is offered as payment for goods and/or services;

automatically and electronically determining whether or not the tendered amount exceeds the total amount required for the purchase of the goods and/or services;

automatically and without approval from the transacting party increasing the total amount of the transaction with a predetermined amount if the tendered amount exceeds the total amount required so that the predetermined amount is equal or less than the difference between the total amount and the tendered amount; and

automatically and electronically allocating the predetermined amount to a collecting party if the transacting party does not disagree to the automatic increase of the total amount with the predetermined amount.

It is to be appreciated that the predetermined amount does not exceed the difference between the total amount and the tendered amount so that the transacting party is not required to tender additional cash than that already tendered. This facilitates the exploitation of the perceived redundancy of change resulting from a cash transaction.

The method may include, after the step of increasing the total amount, the step of displaying the increased total amount and the predetermined amount to the transacting party.

The method may include, after the step of determining whether or not the tendered amount exceeds the total amount, the step of automatically calculating the predetermined amount. The predetermined amount may be calculated so that the addition thereof to the total amount results in a rounded figure, e.g. the total is rounded up to the nearest dollar, i.e. where the total is $43.45, the predetermined amount will be $0.55 so that the increased total is $44.00. The predetermined amount may be calculated so that the total is rounded up to the nearest quarter, nickel, or the like. The predetermined amount may be calculated as a percentage of the total amount of the transaction. The predetermined amount may be a fixed amount. The predetermined amount may be calculated to be below a certain limit, i.e. the predetermined amount does not exceed a specific value. The predetermined amount may be a portion of the difference between the total amount and the tendered amount, i.e. a portion of the change. Otherwise, the predetermined amount may be the entire difference between the total amount and the tendered amount.

The method may further include the step of assigning a unique identifier to the transacting party upon allocation of the predetermined amount to the collecting party which unique identifier is able to uniquely identify the transacting party for the purposes of a game of chance, i.e. a lottery number. The unique identifier may be assigned to the transacting party irrespective of the predetermined amount, i.e. the transacting party may receive the unique identifier regardless of the amount that he donates. It is to be appreciated that the unique identifier is assigned to the transacting party merely through the participation of the transacting party in the transaction. Accordingly, the transacting party does not purchase the unique identifier. The step of assigning unique identifiers to transacting parties may form part of a reward scheme wherein a transacting party has a chance to win a prize merely by donating small change during a transaction.

The method may include the step of providing the transacting party with a printout of the transaction, i.e. a receipt. The printout may show the details of the transaction which includes the predetermined amount and the total amount of the transaction. Accordingly, the printout may include the unique identifier capable of uniquely identifying the transacting party for the purposes of a game of chance.

According to a second aspect of the invention there is provided a system for automatically harvesting a monetary donation during a financial transaction, according to the method as described above, which system includes

at least one conventional electronic transaction register adapted to electronically register tender received from a transacting party which tender is offered as payment for goods and/or services, to automatically and electronically determine whether or not the tendered amount exceeds the total amount required for the purchase of the goods and/or services, and to automatically and without approval from the transacting party increase the total amount of the transaction with a predetermined amount if the tendered amount exceeds the total amount required so that the predetermined amount is equal or less than the difference between the total amount and the tendered amount; and

a central processor arranged in electronic communication with the at least one register which processor is configured to automatically and electronically allocate the predetermined amount by means of a conventional electronic network to a collecting party if the transacting party does not disagree to the automatic increase of the total amount with the predetermined amount.

The register may be adapted to display the increased total amount and the predetermined amount to the transacting party.

The register may be adapted to automatically calculate the predetermined amount. The register may calculate the predetermined amount so that the addition thereof to the total amount results in a rounded figure, e.g. the total amount is rounded up to the nearest dollar, i.e. where the total amount is $43.45, the predetermined amount will be $0.55 so that the increased total is $44.00. The register may calculate the predetermined amount so that the total amount is rounded up to the nearest quarter, nickel, or the like. The register may calculate the predetermined amount as a percentage of the total amount of the transaction. The register may calculate the predetermined amount to be below a certain limit, i.e. the predetermined amount does not exceed a specific value. The register may calculate the predetermined amount to be a portion of the difference between the total amount and the tendered amount, i.e. a portion of the change. Otherwise, the register may calculate the predetermined amount to be the entire difference between the total amount and the tendered amount.

The register may be further adapted to assign a unique identifier to the transacting party upon allocation of the predetermined amount to the collecting party which unique identifier is able to uniquely identify the transacting party for the purposes of a game of chance, i.e. a lottery number. The register may assign the unique identifier to the transacting party irrespective of the predetermined amount, i.e. the transacting party may receive the unique identifier regardless of the amount that he donates. It is to be appreciated that the unique identifier is assigned to the transacting party merely through the participation of the transacting party in the transaction. Accordingly, the transacting party does not purchase the unique identifier. The register may assign unique identifiers to transacting parties so as to form part of a reward scheme wherein a transacting party has a chance to win a prize merely by donating small change during a transaction.

The register may be adapted to provide the transacting party with a printout of the transaction, i.e. a receipt. The printout may show the details of the transaction which includes the predetermined amount and the total amount of the transaction. Accordingly, the printout may include the unique identifier capable of uniquely identifying the transacting party for the purposes of a game of chance.

It is to be appreciated that the conventional register is typically adapted to perform the above functions by configuring a suitable processing means of the register accordingly.

The central processor may include a conventional financial computer server. Accordingly, the central processor may include an electronic storage means for storing information associated with a financial transaction.

According to a third aspect of the invention there is provided a method of automatically harvesting a monetary donation after the conclusion of an electronic transaction which method includes the following steps, in any order

pre-emptively obtaining permission from a transacting party which permission authorizes a financial institution to harvest a donation from an electronic account of a transacting party;

harvesting a donation from the electronic account of the transacting party for which account permission has been granted by automatically increasing the total amount of an electronic transaction with a predetermined amount when the financial institution administers the conventional electronic transfer of the transaction; and

electronically allocating the predetermined amount to a collecting party upon the conventional electronic transfer of the total amount to an electronic account of a third party.

It is to be appreciated that an electronic transaction includes any form of transaction where monetary tender is electronically transferred between parties, such as a purchase and sale transaction, a payment of debt, a fund transfer, a debit order transaction, a credit transaction, authorizing of cheque payments, and/or the like.

The method may include, prior to the step of harvesting a donation, the step of automatically calculating the predetermined amount. The predetermined amount may be calculated so that the addition thereof to the total amount results in a rounded figure. The predetermined amount may be calculated so that the total amount of the transaction is rounded up to the nearest quarter, nickel, or the like. The predetermined amount may be calculated as a percentage of the total amount of the transaction. The predetermined amount may be a fixed amount. The predetermined amount may be calculated to be below a certain limit, i.e. the predetermined amount does not exceed a specific value.

The method may further include the step of assigning a unique identifier to the transacting party upon allocation of the predetermined amount to the collecting party which unique identifier is able to uniquely identify the transacting party for the purposes of a game of chance, i.e. a lottery number. The unique identifier may be assigned to the transacting party irrespective of the predetermined amount, i.e. the transacting party may be assigned the unique identifier regardless of the amount that he donates. It is to be appreciated that the unique identifier is assigned to the transacting party merely through the participation of the transacting party in the transaction. Accordingly, the transacting party does not purchase the unique identifier. The step of assigning unique identifiers to transacting parties may form part of a reward scheme wherein a transacting party has a chance to win a prize merely by automatically making a donation after an electronic transaction.

The method may include the step of providing the transacting party with a printout of the transaction, i.e. a printed statement. The printout may show the details of the electronic transaction which includes the predetermined amount and the total amount of the transaction. Accordingly, the printout may include the unique identifier capable of uniquely identifying the transacting party for the purposes of a game of chance.

According to a fourth aspect of the invention there is provided a system for automatically harvesting a monetary donation after the conclusion of an electronic transaction, according to the method described above, which system includes

authorizing means configured to enable a transacting party to grant permission to a financial institute so that the financial institute can harvest a donation from an account of the transacting party; and

a conventional electronic financial server adapted to harvest a donation from the electronic account of the transacting party for which account permission has been granted by automatically increasing the total amount of an electronic transaction with a predetermined amount when the financial institution administers the conventional electronic transfer of the transaction, and to electronically allocate the predetermined amount to a collecting party upon conventional electronic transfer of the total amount to an electronic account of a third party.

The authorizing means may include receiving permission by means of an electronic network, e.g. the internet, or the like. Otherwise, the authorizing means may include an agreement concluded between the transacting party and the financial institute, e.g. a contract. Accordingly, the authorizing means may include an electronic indication on the electronic account of the transacting party which indication indicates that the transacting party has authorized the harvesting of donations from that particular account.

The conventional electronic financial server may be adapted to calculate the predetermined amount. The server may calculate the predetermined amount so that the addition thereof to the total amount results in a rounded figure. The server may calculate the predetermined amount so that the total amount of the transaction is rounded up to the nearest quarter, nickel, or the like. The server may calculate the predetermined amount as a percentage of the total amount of the transaction. The predetermined amount may be a fixed amount. The server may calculate the predetermined amount to be below a certain limit, i.e. the predetermined amount does not exceed a specific value.

The server may be adapted to assign a unique identifier to the transacting party upon allocation of the predetermined amount to the collecting party which unique identifier is able to uniquely identify the transacting party for the purposes of a game of chance, i.e. a lottery number. The server may assign the unique identifier to the transacting party irrespective of the predetermined amount, i.e. the transacting party may be assigned the unique identifier regardless of the amount that he donates. It is to be appreciated that the unique identifier is assigned to the transacting party merely through the participation of the transacting party in the transaction. Accordingly, the transacting party does not purchase the unique identifier. The step of assigning unique identifiers to transacting parties may form part of a reward scheme wherein a transacting party has a chance to win a prize merely by automatically making a donation after an electronic transaction.

The server may include a printing means for providing the transacting party with a conventional printout of the transaction, i.e. a printed statement. The printout may show the details of the electronic transaction which includes the predetermined amount and the total amount of the transaction. Accordingly, the printout may include the unique identifier capable of uniquely identifying the transacting party for the purposes of a game of chance.

### BRIEF DESCRIPTION OF THE DRAWINGS

The invention is now described, by way of non-limiting example, with reference to the accompanying drawings wherein

FIG. 1 shows a flow diagram for a method of automatically harvesting a monetary donation during a financial transaction, in accordance with the invention;

FIG. 2 shows, in schematic view, a system for automatically harvesting a monetary donation during a financial transaction, in accordance with the invention;

FIG. 3 shows a flow diagram for a method of automatically harvesting a monetary donation after the conclusion of an electronic transaction, in accordance with the invention; and

FIG. 4 shows, in schematic view, a system for automatically harvesting a monetary donation after the conclusion of an electronic transaction, in accordance with the invention.

### DETAILED DESCRIPTION OF THE INVENTION

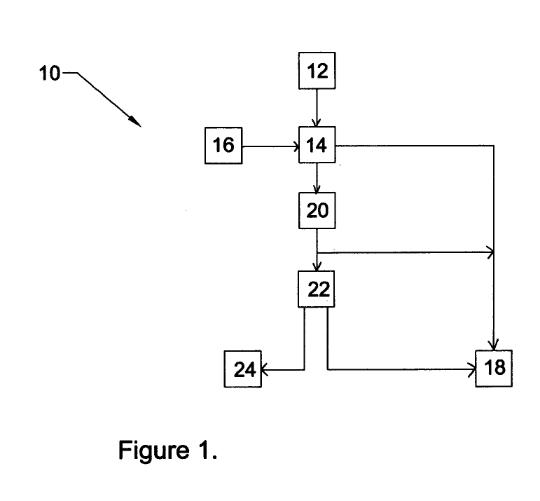

With reference to the accompanying drawings, FIG. 1 shows a flow diagram of a method 10 of automatically harvesting a monetary donation during a financial transaction. The transaction is generally a cash transaction. The method 10 includes the steps of electronically registering 12 tender received from a transacting party which tender is offered as payment for goods and/or services. The method 10 then includes the step of automatically and electronically determining 14 whether or not the tendered amount exceeds the total amount 16 required for the purchase of the goods and/or services. If the tendered amount exceeds the total amount 16, then the method 10 includes the step of automatically and without approval from the transacting party increasing 20 the total amount 16 of the transaction with a predetermined amount so that the predetermined amount is equal or less than the difference between the total amount 16 and the tendered amount.

In the embodiment shown in FIG. 1, should the tendered amount not exceed the total amount 16 of the transaction, then the method merely registers the tendered amount as a conventional transaction 18.

The method 10, if the tendered amount exceeds the total amount 16 of the transaction, then includes the step of automatically and electronically allocating 22 the predetermined amount to a collecting party 24 and the total amount as a conventional transaction 18 if the transacting party does not disagree to the automatic increase of the total amount 16 with the predetermined amount. The transacting party can disagree before the step of allocating 22, whereupon the change of the transaction is returned as in a conventional transaction 18.

It is to be appreciated that the predetermined amount does not exceed the difference between the total amount and the tendered amount so that the transacting party is not required to tender additional cash than that already tendered. This facilitates the exploitation of the perceived redundancy of change resulting from a cash transaction.

In other embodiments (not shown), the method 10 includes, after the step of increasing 20 the total amount, the step of displaying the increased total amount and the predetermined amount to the transacting party. It is to be appreciated that the method 10 will generally be utilized in combination with a marketing stratagem in which potential transacting parties are informed that the predetermined amount is automatically added to the total amount of any purchase. In these circumstances the donation portion may not be displayed to the transacting party.

The method 10 generally includes the step of automatically calculating the predetermined amount after determining 14 whether or not the tendered amount exceeds the total amount 16. The predetermined amount may be calculated so that the addition thereof to the total amount results in a rounded figure, e.g. the total amount is rounded up to the nearest dollar, i.e. where the total is $43.45, the predetermined amount will be $0.55 so that the rounded-up amount is $44.00.

Otherwise, the predetermined amount may be calculated so that the total amount is rounded up to the nearest quarter, nickel, or the like. This lets the transacting party tender the rounded-up amount more easily as he will then not have small change cluttering his wallet. This exploits the perceived redundancy of small change produced by cash transactions. Similarly, in other embodiments, the predetermined amount may be calculated as a percentage of the total amount of the transaction. In a further embodiment the predetermined amount may be a fixed amount.

The predetermined amount is typically calculated to be below a certain limit, i.e. the predetermined amount does not exceed a specific value, otherwise where large transactions are concluded the predetermined amount may result in a large amount which the transacting party may disagree to donate. Accordingly, in certain situations the predetermined amount will be a portion of the difference between the total amount and the tendered amount, i.e. a portion of the change. Otherwise, the predetermined amount may be the entire difference between the total amount and the tendered amount, especially where small transactions are concluded which results in little change to the transacting party.

Furthermore, in other embodiments (not shown), the method 10 may further include the step of assigning a unique identifier to the transacting party upon allocation 22 of the predetermined amount to the collecting party 24 which unique identifier is able to uniquely identify the transacting party for the purposes of a game of chance, i.e. a lottery number. It is to be appreciated that the unique identifier is assigned to the transacting party irrespective of the predetermined amount, i.e. the transacting party receives the unique identifier regardless of the amount that he donates. The unique identifier is thus assigned to the transacting party merely through the participation of the transacting party in the transaction. Accordingly, the transacting party does not purchase the unique identifier. The step of assigning unique identifiers to transacting parties may form part of a reward scheme wherein a transacting party has a chance to win a prize merely by donating small change during a transaction.

In a yet further embodiment of the invention (not shown), the method 10 may include the step of providing the transacting party with a printout of the transaction, i.e. a receipt. The printout generally shows the details of the transaction which includes the predetermined amount and the total amount of the transaction. Similarly, the printout may, where applicable, include the unique identifier capable of uniquely identifying the transacting party for the purposes of a game of chance.

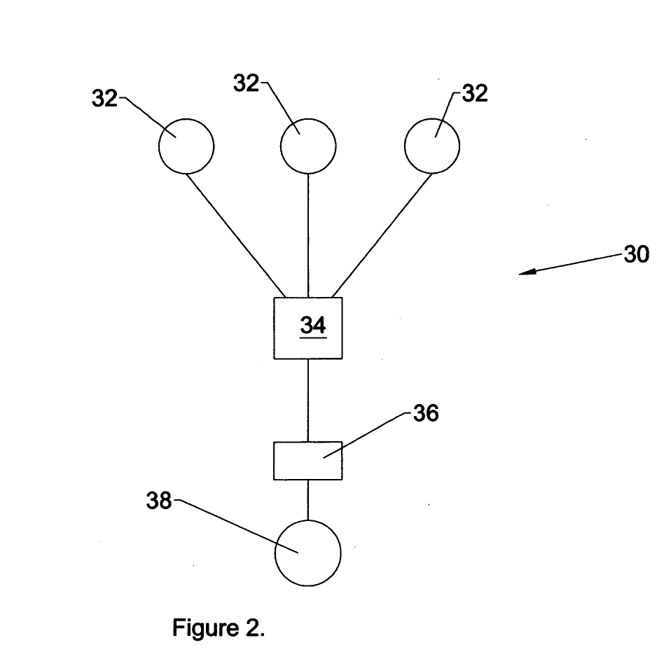

With reference to the accompanying drawings, FIG. 2 shows a system 30 for automatically harvesting a monetary donation during a financial transaction, according to the method 10 as described above.

The system 30 includes at least one conventional electronic transaction register 32 adapted to electronically register tender received by the transacting party which tender is offered as payment for goods and/or services. The register 32 is further adapted to automatically and electronically determine whether or not the tendered amount exceeds the total amount required for the purchase of the goods and/or services. The register 32 then to automatically and without approval from the transacting party increases the total amount of the transaction with a predetermined amount if the tendered amount exceeds the total required amount so that the predetermined amount is equal or less than the difference between the total amount and the tendered amount.

The system 30 also includes a central processor 34 arranged in electronic communication with the at least one register 32 which processor 34 is configured to automatically and electronically allocate the predetermined amount by means of a conventional electronic network 36 to a collecting party 38 if the transacting party does not disagree to the automatic increase of the total amount with the predetermined amount.

It is to be appreciated that the system 30 automatically adds a donation in the form of the predetermined amount to the due total of a transacting party. The Inventor has noticed that this is a more efficient way of collecting donations from people making purchases, as it is not generally human nature to perform a positive and conscious act to withhold a donation. This is especially true where the predetermined amount is not very significant, i.e. small change perceived as redundant. A transacting party is less likely to donate this small change than to merely agree to tender an amount which already includes the donation.

The register 32 is generally adapted to display the increased total amount and the predetermined amount to the transacting party.

The register 32 is adapted to automatically calculate the predetermined amount. It is to be appreciated that the predetermined amount may be calculated in different ways depending on the transaction. Accordingly, the register 32 may calculate the predetermined amount so that the addition thereof to the total amount results in a rounded figure, e.g. the increased monetary value is rounded up to the nearest dollar, i.e. where the total amount is $43.45, the predetermined amount will be $0.55 so that the increased total is $44.00. Otherwise, the register 32 may calculate the predetermined amount so that the total amount is rounded up to the nearest quarter, nickel, or the like. The register 32 may calculate the predetermined amount as a percentage of the total amount of the transaction. The register 32 may calculate the predetermined amount to be below a certain limit, i.e. the predetermined amount does not exceed a specific value. The register 32 may calculate the predetermined amount to be a portion of the difference between the total amount and the tendered amount, i.e. a portion of the change. Otherwise, the register 32 may calculate the predetermined amount to be the entire difference between the total amount and the tendered amount.

In further embodiments (not shown), the register 32 may be further adapted to assign a unique identifier to the transacting party upon allocation of the predetermined amount to the collecting party which unique identifier is able to uniquely identify the transacting party for the purposes of a game of chance, i.e. a lottery number. The register 32 will typically assign the unique identifier to the transacting party irrespective of the predetermined amount, i.e. the transacting party receives the unique identifier regardless of the amount that he donates. It is to be appreciated that the unique identifier is assigned to the transacting party merely through the participation of the transacting party in the transaction. Accordingly, the transacting party does not purchase the unique identifier. The register 32 generally assigns unique identifiers to transacting parties so as to form part of a reward scheme wherein a transacting party has a chance to win a prize merely by donating small change during a transaction.

The register 32 is typically adapted to provide the transacting party with a printout of the transaction, i.e. a receipt. The printout will show the details of the transaction which includes the predetermined amount and the total amount of the transaction. Accordingly, the printout may also include the unique identifier capable of uniquely identifying the transacting party for the purposes of a game of chance.

It is to be appreciated that the conventional register 32 is typically adapted to perform the above functions by configuring a suitable processing means of the register 32 accordingly, e.g. running a certain set of instructions, or the like.

The central processor 34 is a conventional financial computer server used in managing and regulating financial transactions. Accordingly, the central processor 34 includes an electronic storage means (not shown) for storing information associated with a financial transaction.

It is to be appreciated that the method 10 and system 30 described in FIGS. 1 and 2, respectively, finds application where the transaction is concluded by cash. The following method and system finds application on the banking side of a transaction to enable the harvesting of donations.

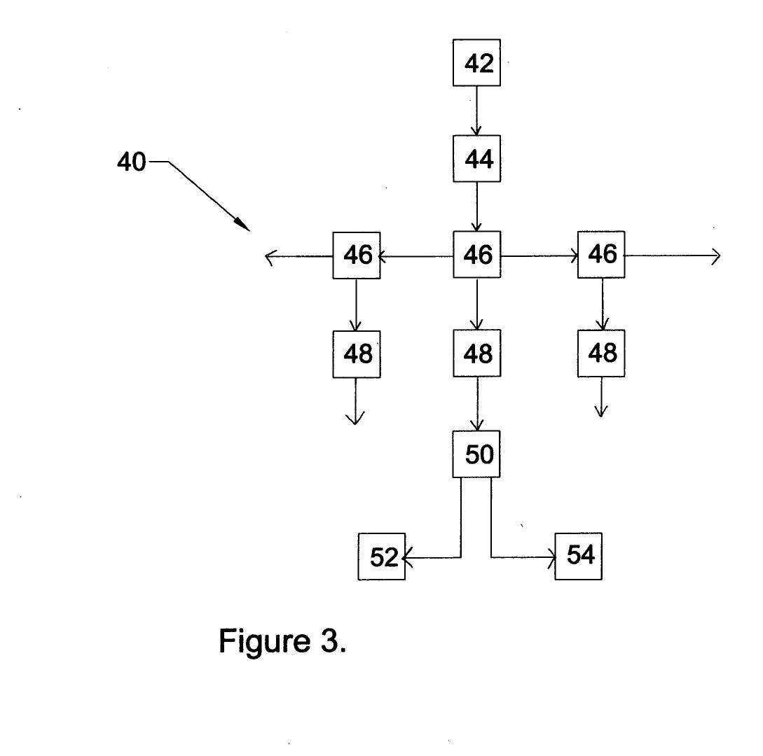

With reference to the accompanying drawings, FIG. 3 shows a method 40 of automatically harvesting a monetary donation after the conclusion of an electronic transaction. The method 40 includes the steps of preemptively obtaining 42 permission from a transacting party which permission authorizes a financial institution to harvest a donation from an electronic account 44 of the transacting party. The method 40 then includes the step of harvesting a donation from the electronic account of the transacting party for which account permission has been granted by automatically increasing 48 the total amount of an electronic transaction 46 with a predetermined amount when the financial institution administers the conventional electronic transfer of the transaction 46. The method 40 then performs the step of electronically allocating 50 the predetermined amount to a collecting party 52 upon the conventional electronic transfer of the total amount to an electronic account of a third party 54.

FIG. 3 shows an example of a single account 44 of the transacting party being harvested when transactions 46 are made. FIG. 3 shows that the harvesting of donations is done for each separate transaction 46.

The method 40 includes the step of automatically calculating (not shown) the predetermined amount. The predetermined amount may be calculated so that the addition thereof to the total amount results in a rounded figure. The predetermined amount may be calculated so that the total amount of the transaction is rounded up to the nearest quarter, nickel, or the like. The predetermined amount may be calculated as a percentage of the total amount of the transaction. The predetermined amount may be a fixed amount. The predetermined amount may be calculated to be below a certain limit, i.e. the predetermined amount does not exceed a specific value.

The method 40 further includes the step of assigning (not shown) a unique identifier to the transacting party upon allocation of the predetermined amount to the collecting party which unique identifier is able to uniquely identify the transacting party for the purposes of a game of chance, i.e. a lottery number. The unique identifier is generally assigned to the transacting party irrespective of the predetermined amount, i.e. the transacting party is assigned the unique identifier regardless of the amount that he donates. It is to be appreciated that the unique identifier is assigned to the transacting party merely through the participation of the transacting party in the transaction. Accordingly, the transacting party does not purchase the unique identifier. The step of assigning unique identifiers to transacting parties may form part of a reward scheme wherein a transacting party has a chance to win a prize merely by automatically making a donation after an electronic transaction.

The method 40 also includes the step of providing (not shown) the transacting party with a printout of the transaction, i.e. a printed statement. The printout typically shows the details of the electronic transaction which includes the predetermined amount and the total amount of the transaction. Accordingly, the printout may include the unique identifier capable of uniquely identifying the transacting party for the purposes of a game of chance.

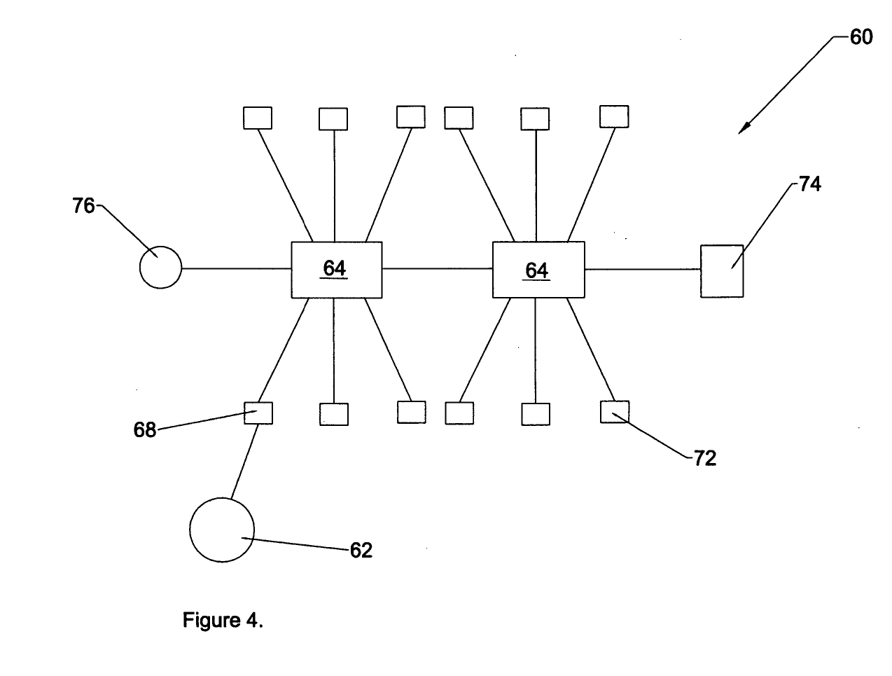

With reference to the accompanying drawings, FIG. 4 shows a system 60 for automatically harvesting a monetary donation after the conclusion of an electronic transaction, according to the method 40 described above.

The system 60 includes authorizing means 62 configured to enable a transacting party to grant permission to a financial institute so that the financial institute can harvest a donation from an account 68 of the transacting party. The system 60 further includes a conventional electronic financial server 64 adapted to harvest a donation from an electronic account 68 of the transacting party, for which account 68 permission has been granted, by automatically increasing the total amount of an electronic transaction with a predetermined amount when the financial institution administers the conventional electronic transfer of the transaction. The server 64 is further adapted to electronically allocate the predetermined amount to a collecting party 74 upon conventional electronic transfer of the total amount to an electronic account 72 of a third party.

It is to be appreciated that the collecting party 74 is generally a further electronic account. The account 72 of the third party is the conventional account of a third party for whom the total amount of the transaction is intended, e.g. an account of a shop which sells goods, or the like.

The authorizing means 62 may include receiving permission by means of an electronic network, e.g. the internet, or the like. Otherwise, the authorizing means 62 may include an agreement concluded between the transacting party and the financial institute, e.g. a contract. Accordingly, the authorizing means 62 may include an electronic indication on the electronic account 68 of the transacting party which indication indicates that the transacting party has authorized the harvesting of donations from that particular account 68.

The conventional electronic financial server 64 is adapted to calculate the predetermined amount. The server 64 may calculate the predetermined amount so that the addition thereof to the total amount results in a rounded figure. The server 64 may calculate the predetermined amount so that the total amount of the transaction is rounded up to the nearest quarter, nickel, or the like. The server 64 may calculate the predetermined amount as a percentage of the total amount of the transaction. The predetermined amount may be a fixed amount. The server 64 may calculate the predetermined amount to be below a certain limit, i.e. the predetermined amount does not exceed a specific value.

The server 64 may be adapted to assign a unique identifier to the transacting party upon allocation of the predetermined amount to the collecting party which unique identifier is able to uniquely identify the transacting party for the purposes of a game of chance, i.e. a lottery number. The server 64 may assign the unique identifier to the transacting party irrespective of the predetermined amount, i.e. the transacting party may be assigned the unique identifier regardless of the amount that he donates. It is to be appreciated that the unique identifier is assigned to the transacting party merely through the participation of the transacting party in the transaction. Accordingly, the transacting party does not purchase the unique identifier. The step of assigning unique identifiers to transacting parties may form part of a reward scheme wherein a transacting party has a chance to win a prize merely by automatically making a donation after an electronic transaction.

The server 64 includes a printing means 76 for providing the transacting party with a conventional printout of the transaction, i.e. a printed statement. The printout may show the details of the electronic transaction which includes the predetermined amount and the total amount of the transaction. Accordingly, the printout may include the unique identifier capable of uniquely identifying the transacting party for the purposes of a game of chance.

It shall be understood that the example is provided for illustrating the invention further and to assist a person skilled in the art with understanding the invention and is not meant to be construed as unduly limiting the reasonable scope of the invention.

The Inventor regards it as an advantage that the invention enables a more efficient method of harvesting donations during financial transactions by requiring a transacting party to perform a positive act to abstain from making a donation, as opposed to current systems which require a transacting party to perform a positive act to make a donation. Accordingly, the Inventor regards it as an advantage that the invention, by not requiring a transacting party to make a decision of donating, offers a more efficient and simple solution than existing donation harvesting systems. These advantages further ensure that the current invention facilitates more efficient harvesting of donations during financial transactions.

The Inventor regards it as a further advantage that the invention makes use of existing components generally in use during financial transactions alleviating the need for additional and expensive equipment.

1. A method of automatically harvesting a monetary donation during a financial transaction which method includes the following steps, in any order
electronically registering tender received from a transacting party which tender is offered as payment for goods and/or services;
automatically and electronically determining whether or not the tendered amount exceeds the total amount required for the purchase of the goods and/or services;
automatically and without approval from the transacting party increasing the total amount of the transaction with a predetermined amount if the tendered amount exceeds the total amount required so that the predetermined amount is equal or less than the difference between the total amount and the tendered amount; and
automatically and electronically allocating the predetermined amount to a collecting party if the transacting party does not disagree to the automatic increase of the total amount with the predetermined amount.

2. A method as claimed in claim 1, which includes, after the step of increasing the total amount, the step of displaying the increased total amount and the predetermined amount to the transacting party.

3. A method as claimed in claim 1, which includes, after the step of determining whether or not the tendered amount exceeds the total amount, the step of automatically calculating the predetermined amount.

4. A method as claimed in claim 1, wherein the predetermined amount is calculated so that the addition thereof to the total amount results in a rounded figure.

5. A method as claimed in claim 1, wherein the predetermined amount is calculated as a percentage of the total amount of the transaction.

6. A method as claimed in claim 1, wherein the predetermined amount is calculated to be below a certain limit.

7. A method as claimed in claim 1, which includes the step of assigning a unique identifier to the transacting party upon allocation of the predetermined amount to the collecting party which unique identifier is able to uniquely identify the transacting party for the purposes of a game of chance.

8. A method as claimed in claim 7, wherein the step of assigning a unique identifier to a transacting party forms part of a reward scheme wherein a transacting party has a chance to win a prize merely by donating small change during a transaction.

9. A method as claimed in claim 1, which includes the step of providing the transacting party with a printout of the transaction.

10. A system for automatically harvesting a monetary donation during a financial transaction which system includes
at least one conventional electronic transaction register adapted to electronically register tender received from a transacting party which tender is offered as payment for goods and/or services, to automatically and electronically determine whether or not the tendered amount exceeds the total amount required for the purchase of the goods and/or services, and to automatically and without approval from the transacting party increase the total amount of the transaction with a predetermined amount if the tendered amount exceeds the total amount required so that the predetermined amount is equal or less than the difference between the total amount and the tendered amount; and
a central processor arranged in electronic communication with the at least one register which processor is configured to automatically and electronically allocate the predetermined amount by means of a conventional electronic network to a collecting party if the transacting party does not disagree to the automatic increase of the total amount with the predetermined amount.

11. A system as claimed in claim 10, wherein the register is adapted to display the increased total amount and the predetermined amount to the transacting party.

12. A system as claimed in claim 10, wherein the register is adapted to automatically calculate the predetermined amount.

13. A system as claimed in claim 10, wherein the register calculates the predetermined amount so that the addition thereof to the total amount results in a rounded figure.

14. A system as claimed in claim 13, wherein the register calculates the predetermined amount as a percentage of the total amount of the transaction.

15. A system as claimed in claim 10, wherein the register calculates the predetermined amount to be below a certain limit.

16. A system as claimed in claim 10, wherein the register is adapted to assign a unique identifier to the transacting party upon allocation of the predetermined amount to the collecting party which unique identifier is able to uniquely identify the transacting party for the purposes of a game of chance.

17. A system as claimed in claim 16, wherein the register assigns the unique identifier to a transacting party so as to form part of a reward scheme wherein a transacting party has a chance to win a prize merely by donating small change during a transaction.

18. A system as claimed in claim 10, wherein the register is adapted to provide the transacting party with a printout of the transaction.

19. A system as claimed in claim 10, wherein the central processor includes a conventional financial computer server.
